(19) United States
(12) Patent Application Publication
(10) Pub. No.: US 2007/0248335 A1
(43) Pub. Date: Oct. 25, 2007

(54) Information Recording Medium, Information Recording Device and Method, and Computer Program

(76) Inventor: Kazuo Kuroda, Saitama (JP)

Correspondence Address: YOUNG & THOMPSON, 745 SOUTH 23RD STREET, 2ND FLOOR, ARLINGTON, VA, 22202, US

(21) Appl. No.: 11/659,279

(22) PCT Filed: Aug. 1, 2005
(86) PCT No.: PCT/JP05/14043

§ 371 Date: Apr. 2, 2007

(30) Foreign Application Priority Data
Aug. 3, 2004 (JP) 2004-226725

(51) Int. Cl. H04N 5/00; G11B 7/24

(52) U.S. Cl. 386/126; 720/718

(57) ABSTRACT

An information recording medium (100) is provided with: a first data area (106) in which first data having a form compliant with a predetermined format is recorded in advance; and a second data area (122) to record therein second data used with the first data in order to reproduce content data having a form compliant with the predetermined format.

### TECHNICAL FIELD

The present invention relates to an information recording medium, such as a DVD, an information recording apparatus, such as a DVD recorder, an information recording method, and a computer program which makes a computer as the information recording apparatus.

### BACKGROUND ART

Currently, a hybrid type optical disc is proposed and is under development, wherein the hybrid type optical disc has a recordable recording area, which is the same as that of a recordable type optical disc, such as a CD-R and a DVD-R, and a read-only recording area, which is the same as that of a read-only type optical disc, such as a CD-ROM and a DVD-ROM, with the both areas separated in the outer area and the inner area of one optical disc.

Specifically, the hybrid type optical disc is practically used as a CPRM (Content Protection for Prerecorded Media)-compliant optical disc aimed at the copyright protection of contents. The CPRM-compliant optical disc is constructed to record in advance an encryption key for encrypting content data in a read-only recording area as an embossed pit, and to record the content data into the recordable recording area by using the encryption key. Even if the content data is illegally copied or duplicated onto the CPRM-compliant optical disc from the read-only information recording medium, such as a DVD-ROM, it is impossible to record the encryption key into the read-only recording area Even if the encryption key is recorded, the embossed pit recorded in advance and a record mark newly recorded interfere to thereby disable the encryption key to be properly read. Therefore, it results in not allowing the illegal copy of the content data, so that the copyright of the content data can be preferably protected.

### DISCLOSURE OF INVENTION

### Subject to be Solved by the Invention

In the hybrid type optical disc, however, the read-only recording area and the recordable recording area are clearly separated. For example, the read-only recording area is disposed on the relatively inner circumferential side of the optical disc, and the recordable recording area is disposed on the relatively outer circumferential side of the optical disc. Thus, there is such a technical problem that the data to be recorded into the recordable recording area cannot be recorded in an optimum recording position in association with the data recorded in the read-only recording area.

In order to solve the above-mentioned problem, it is therefore an object of the present invention to provide an information recording medium, an information recording apparatus, and an information recording method, which enable preferable data recording and reproduction, and a computer program which makes a computer as the information recording apparatus, for example.

### MEANS FOR SOLVING THE SUBJECT

(Information Recording Medium)

The above object of the present invention can be achieved by an information recording medium provided with: a first data area in which first data having a form compliant with a predetermined format is recorded in advance; and a second data area to record therein second data used with (or used to complement) the first data in order to reproduce content data having a form compliant with the predetermined format.

According to the information recording medium of the present invention, in the first data area, the first data having the form compliant with the predetermined format is recorded in advance. The first data may be set non-rewritable (or read-only), or writable (or overwritable). On the other hand, in the second data area, the second data used in a complementary manner with the first data in order to reproduce the predetermined content data is recorded. In particular, the second data is preferably recorded by a user of the information recording medium.

Therefore, for example, by preferably disposing the second data area with respect to the first data area in order to comply with the predetermined format, it is possible to properly associate the first data recorded in advance in the first data area, with the second data to be recorded into the second data area. Therefore, the first data and the second data can be combined more properly, to thereby reproduce the desired content data compliant with the predetermined format.

Moreover, the first data is recorded in advance in the first data area in the form compliant with the predetermined format, so that it is unnecessary to record the first data in consideration of the predetermined format. Namely, in order to record the desired content data, it is only necessary for the user to record the second data into the second data area. Therefore, for example, the user does not have to perform authoring on the information recording medium, so that it is possible to reduce the user's load about the preparation of the information recording medium (i.e. about the recording of the content data) on which the content data is recorded.

Consequently, according to the information recording medium of the present invention, it is possible to preferably record the second data in proper association with the first data recorded in advance, and it is also possible to reduce the load required to prepare the information recording medium on which the content data is recorded.

In one aspect of the information recording medium of the present invention, it is further provided with a position information area to record therein position information indicating a position of the second data area.

According to this aspect, by referring to the position information, it is possible to recognize the position of the second data area, relatively easily. Therefore, it is possible to preferably record the second data into the second data area, on the basis of the position information.

In another aspect of the information recording medium of the present invention, the second data area is disposed in the first data area with being compliant with the predetermined format.

According to this aspect, it is possible to record the second data in proper association with the first data recorded in advance in the first data area. Therefore, the first data and the second data can be combined more properly, to thereby reproduce the desired content data compliant with the predetermined format.

In addition, the second data area is disposed in the first data area, so that it is possible to reduce a time length required for operations of alternately seeking or searching for the first data and the second data.

In another aspect of the information recording medium of the present invention, the second data area comprises a dummy area to record therein dummy data, in a boundary with the first data area.

According to this aspect, even if the second data is recorded adjacent to the first data recorded in advance, there is no influence on the first data due to the recording of the second data, or on the second data due to the presence of the first data. Therefore, it is possible to preferably read each of the first data and the second data.

In another aspect of the information recording medium of the present invention, the second data area has a data size of an integral multiple of a smallest recoding unit.

According to this aspect, it is possible to perform the recording and rewriting of the second data, by each recording unit.

In another aspect of the information recording medium of the present invention, it is provided with a plurality of second data areas.

According to this aspect, it is possible to record the second data, which can be combined with the first data, as much as possible and more preferably, in association with the first data. By this, it is possible to reproduce the desired content data.

In another aspect of the information recording medium of the present invention, the plurality of second data areas are discretely or continuously disposed in the first data area, with being compliant with the predetermined format.

According to this aspect, it is possible to preferably record the second data into a desired recording position, in association with the first data recorded in advance in the first data area. Therefore, the first data and the second data can be combined more preferably, to thereby reproduce the desired content data.

In another aspect of the information recording medium of the present invention, the first data and the second data are recorded, with being compliant with a first application for performing at least one of recording and reproduction of the content data compliant with the predetermined format.

According to this aspect, the first data and the second data are recorded in the predetermined format with which the first application is compliant. Therefore, it is possible to optimize the arrangement of the first data and the second data, in accordance with the usage or the first application (or the predetermined format with which the first application is compliant), for example.

In this aspect, the predetermined format is a DVD-Video format, the first application is a DVD-Video application, and the second data includes at least one of video data, audio data, and still image data.

By virtue of such construction, by the operation of the DVD-Video application, it is possible to preferably reproduce DVD-Video contents (i.e. content data) constructed by combining the first data and the second data. Then, by rewriting the second data, as occasion demands, it is possible to reproduce various DVD-Video contents with different videos, various DVD-Video contents with different audio, and various DVD-Video contents with different still images. By this, it is possible to reproduce the content data (i.e. DVD-Video contents) in an aspect that the user desires, for example.

In this aspect, the predetermined format is a DVD-VR format, the first application is a DVD-VR application, and the second data includes at least one of video data, audio data, and still image data.

By virtue of such construction, by the operation of the DVD-VR application, it is possible to preferably reproduce DVD-VR contents (i.e. content data) constructed by combining the first data and the second data. Then, by rewriting the second data, as occasion-demands, it is possible to reproduce various DVD-VR contents with different videos, various DVD-VR contents with different audio, and various DVD-VR contents with different still images. By this, it is possible to reproduce the content data (i.e. DVD-VR contents) in an aspect that the user desires, for example.

In this aspect, the predetermined format is a format used for slide show reproduction of still images, the first application is a slide show application capable of performing the slide show reproduction of still images, and the second data includes still image data.

By virtue of such construction, by the operation of the slide show application, it is possible to perform the slide show reproduction using a plurality of still image data, by combining the first data and the second data. Then, by rewriting the second data, as occasion demands, it is possible to reproduce the desired still image data in the slide show in desired order, for example.

In another aspect of the information recording medium of the present invention, it is further provided with a third data area in which the second data to be recorded into the second data area is recorded in advance.

According to this aspect, it is possible to record the second data recorded in advance in the third data area, into the second data area. In addition, if a plurality of second data are recorded in the third data area, for example, the desired second data can be selected from the plurality of second data and recorded into the second data area. Thus, it is also possible to change the aspect of the content data to be reproduced, variously.

In another aspect of the information recording medium of the present invention, it is further provided with an application area to record therein a second application capable of reproducing the second data recorded in advance in the third data area.

According to this aspect, even if the second data is not recorded into the second data area, the second data itself can be reproduced, for example. Therefore, it is possible to use the second data, more efficiently.

(Information Recording Apparatus)

The above object of the present invention can be also achieved by an information recording apparatus for recording the second data onto the above-mentioned information recording medium of the present invention (including its various aspects), the information recording apparatus provided with: an obtaining device for obtaining the second data; and a recording device for recording the obtained second data into the second data area.

According to the information recording apparatus of the present invention, by the operation of the obtaining device, the second data (preferably, the desired second data) can be obtained. Then, by the operation of the recording device, the obtained second data is recorded into the second data area (preferably, the desired second data area). Therefore, it is possible to preferably record the second data onto the information recording medium of the present invention. As a result, it is possible to receive the same various benefits as those owned by the information recording medium of the present invention.

Incidentally, in response to the various aspects of the above-mentioned information recording medium of the present invention, the information recording apparatus of the present invention can also adopt various aspects.

In one aspect of the information recording apparatus of the present invention, the information recording medium further comprises a position information area to record therein position information indicating a position of the second data area, the information recording apparatus further comprises a recognizing device for recognizing the position of the second data area by referring to the position information, and the recording device records the second data while referring to the recognized position of the second data area.

According to this aspect, it is possible to recognize the position of the second data area, relatively easily, by referring to the position information. Therefore, it is possible to preferably record the second data.

In another aspect of the information recording apparatus of the present invention, the recording device records dummy data into a boundary with the first data area out of the second data area.

According to this aspect, even if the second data is recorded adjacent to the first data recorded in advance, there is no influence on the first data due to the recording of the second data, or on the second data due to the presence of the first data. Therefore, it is possible to record the second data so as to preferably read each of the first data and the second data.

In another aspect of the information recording apparatus of the present invention, the information recording medium further comprises a third data area in which the second data to be recorded into the second data area is recorded in advance, and the obtaining device obtains the second data from the third data area.

According to this aspect, it is possible to obtain the second data recorded in advance in the third data area, and record it into the second data area. In addition, if a plurality of second data are recorded in the third data area, for example, the desired second data can be selected from the plurality of second data and recorded into the second data area. Thus, it is also possible to change the aspect of the content data to be reproduced, variously.

In another aspect of the information recording apparatus of the present invention, the obtaining device obtains the second data from an external recording device on which the second data is recorded in advance.

According to this aspect, it is possible to record the second data obtained from the external recording medium on which the various second data can be recorded, onto the information recording medium. Thus, it is also possible to change the aspect of the content data to be reproduced, variously.

In an aspect of the information recording apparatus in which the second data is obtained from the external recording medium, as described above, the second data may be recorded on the external recording device having a form compliant with the predetermined format.

By virtue of such construction, it is possible to record the second data obtained from the external recording medium, into the second data area, without performing a special process, such as format conversion, on the second data. Therefore, it is possible to further reduce the use's load who records the content data.

In another aspect of the information recording apparatus of the present invention, the predetermined format is a DVD-Video format, and the recording device records at least one of video data, audio data, and still image data, as the second data.

According to this aspect, it is possible to preferably reproduce DVD-Video contents (i.e. content data) constructed by combining the first data and the second data. Then, by rewriting the second data, as occasion demands, by the operation of the recording device, it is possible to reproduce various DVD-Video contents with different videos, various DVD-Video contents with different audio, and various DVD-Video contents with different still images. By this, it is possible to reproduce the content data (i.e. DVD-Video contents) in an aspect that the user desires, for example.

In another aspect of the information recording apparatus of the present invention, the predetermined format is a DVD-VR format, and the recording device records at least one of video data, audio data, and still image data, as the second data.

By virtue of such construction, it is possible to preferably reproduce DVD-VR contents (i.e. content data) constructed by combining the first data and the second data. Then, by rewriting the second data, as occasion demands, by the operation of the recording device, it is possible to reproduce various DVD-VR contents with different videos, various DVD-VR contents with different audio, and various DVD-VR contents with different still images. By this, it is possible to reproduce the content data (i.e. DVD-VR contents) in an aspect that the user desires, for example.

In another aspect of the information recording apparatus of the present invention, the predetermined format is a format used for slide show reproduction of still images, the recording device records at least still image data, as the second data.

By virtue of such construction, it is possible to perform the slide show reproduction using a plurality of still image data, by combining the first data and the second data. Then, by rewriting the second data, as occasion demands, by the operation of the recording device, it is possible to reproduce the desired still image data in the slide show in desired order, for example. Thus, it is possible to perform the flexible slide show reproduction in a more preferable aspect for the user.

(Information Recording Method)

The above object of the present invention can be also achieved by an information recording method of recording the second data onto the above-mentioned information recording medium of the present invention (including its various aspects), the information recording method provided with: an obtaining process of obtaining the second data; and a recording process of recording the obtained second data into the second data area.

According to the information recording method of the present invention, it is possible to receive the various benefits owned by the above-mentioned information recording apparatus of the present invention.

Incidentally, in response to the various aspects of the above-mentioned information recording apparatus of the present invention, the information recording method of the present invention can also adopt various aspects.

In one aspect of the information recording method of the present invention, the characteristic information includes a layer identification flag indicating an identification number of each of the recording layers, in the obtaining process, the layer identification flag is obtained, and in the recording process, the recording information is recorded into a desired recording layer out of the plurality of recording layers, on the basis of the obtained layer identification flag.

According to this aspect, it is possible to identify each of the plurality of recording layers, on the basis of the layer identification flag. Therefore, even if the laser light is mistakenly focused on the unexpected recording layer or even in similar cases, for example, it is possible to recognize the incorrect focusing on the recording layer, relatively easily and quickly (or immediately or instantly). Alternatively, it is possible to properly focus on the recording layer to be originally focused on, from the start of the recording operation. By this, with respect to the information recording medium having the plurality of recording layers, the record information can be recorded preferably into the desired recording layer.

(Computer Program)

The above object of the present invention can be also achieved by a computer program making a computer to function as at least one part of the above-mentioned information recording apparatus of the present invention (including its various aspects). Specifically, the computer program makes the computer function as at least one portion of the obtaining device and the recording device.

According to the computer program of the present invention, the above-mentioned information recording apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the above-mentioned information recording apparatus of the present invention, the computer program of the present invention can also adopt various aspects.

The above object of the present invention can be also achieved by a computer program product in a computer-readable medium for tangibly embodying a program of instructions executable by a computer provided in the above-mentioned information recording apparatus of the present invention (including its various aspects), to make the computer function as at least one portion of the obtaining device and the recording device.

According to the computer program product of the present invention, the above-mentioned information recording apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the above-mentioned information recording apparatus of the present invention.

These effects and other advantages of the present invention will become more apparent from the following embodiments.

As explained above, according to the information recording medium of the present invention, it is provided with the first data area in which the first data is recorded in advance, and the second data area to record therein the second data. Therefore, it is possible to record the second data in proper association with the first data recorded in advance, and it is also possible to reduce the load required to prepare the information recording medium on which the content data is to be recorded.

As explained above, according to the information recording apparatus of the present invention, it is provided with the obtaining device and the recording device, and according to the information recording method of the present invention, it is provided with the obtaining process and the recording process. Therefore, it is possible to preferably record the second data onto the information recording medium of the present invention.

### BRIEF DESCRIPTION OF DRAWINGS

FIG. 1 is a substantial plan view showing the basic structure of an optical disc having a plurality of record areas in an embodiment of the information record medium of the present invention, and a schematic cross sectional view of the optical disc and a corresponding conceptual diagram showing a recording area structure in the radial direction.

FIG. 2 is an explanatory diagram conceptually showing recording areas further segmentalized in a user data area of the optical disc in the embodiment.

FIG. 3 is an explanatory diagram conceptually showing an aspect in which still image data is recorded into a rewritable area provided for the optical disc in the embodiment.

FIG. 4 is an explanatory diagram conceptually showing the basic structure of a slide show.

FIG. 5 is an explanatory diagram conceptually showing a dummy area provided on the optical disc 100 in the embodiment.

FIG. 6 is an explanatory diagram conceptually showing the specific data structure of an information recording medium in a modified example.

FIG. 7 is a block diagram showing an information recording/reproducing apparatus as an embodiment of the information recording apparatus of the present invention and a host computer.

FIG. 8 is a flowchart conceptually showing an entire flow of the recording operation of the information recording/reproducing apparatus in the embodiment.

FIG. 9 is an explanatory diagram conceptually showing the recording operation in a modified example.

FIG. 10 is a flowchart conceptually showing a flow of the recording operation in the modified example.

### DESCRIPTION OF REFERENCE CODES

100 optical disc
106 user data area
111 DVD-Video file area
112 still image data area
113 position data area
114 still image reproducing application area
122 rewritable area
122a dummy area
300 information recording/reproducing apparatus
352 optical pickup
353 signal recording/reproducing device
354 CPU

### BEST MODE FOR CARRYING OUT THE INVENTION

Hereinafter, the best mode for carrying out the invention will be explained in order in each embodiment with reference to the drawings.

Hereinafter, embodiments of the present invention will be explained with reference to the drawings.

(Information Recording Medium)

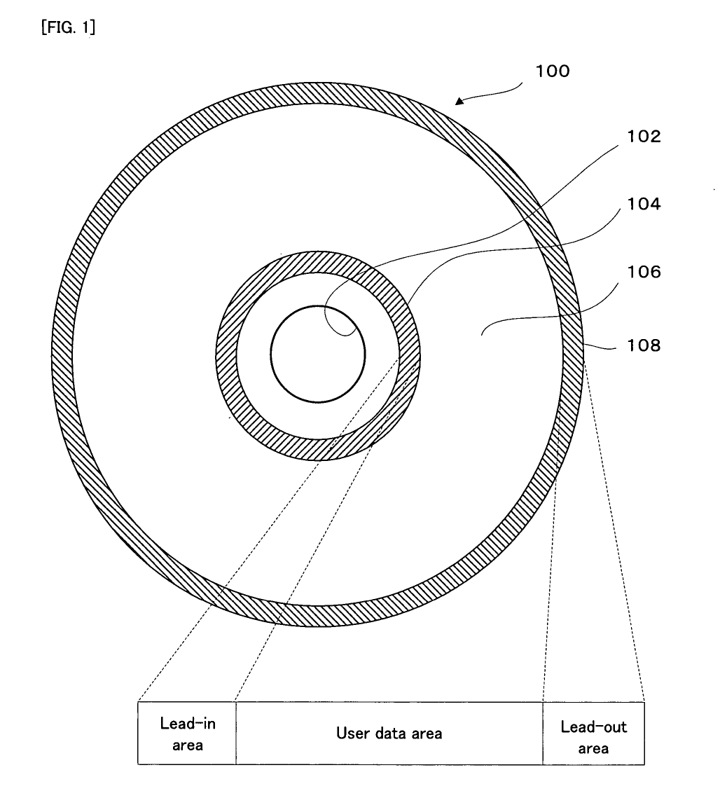

Firstly, with reference to FIG. 1 to FIG. 6, an embodiment of the information recording medium of the present invention will be explained.

(1) Basic Structure

Firstly, with reference to FIG. 1, the basic structure of an optical disc in the embodiment of the information record medium of the present invention will be explained. FIG. 1 shows the structure of the optical disc having a plurality of areas on the upper side in a substantial plan view in association with the area structure in the radial direction on the lower side in a conceptual diagram.

As shown in FIG. 1, an optical disc 100 is recordable in various recoding methods, such as a magneto optical method and a phase changing method, in which data can be recorded a plurality of times or only once. The optical disc 100 has a recording surface on the disc main body, which is about 12 cm in diameter, as is the DVD. On the recording surface, the optical disc 100 is provided with: a center hole 102 as the center; a lead-in area 104; a user data area 106; and a lead-out area 108, from the inner circumference to the outer circumference. Incidentally, in each area, a groove track GT and a land track LT are alternately placed, spirally or coaxially, centered on the center hole 102, for example. The groove track GT may be wobbled, and pre-pits may be formed on either or both of the groove track GT and the land track LT.

Incidentally, the present invention is not specially limited to the optical disc having these three areas. For example, even if there is no lead-in area 104 nor lead-out area 108, a file structure described later can be constructed. Moreover, the lead-in area 104 and the lead-out area 108 may be further segmentalized.

Moreover, the optical disc 100 in the embodiment is not limited to an optical disc with one recording layer, but may be a two-layer single sided (i.e. a dual layer) disc or a two-layer double sided (i.e. a dual layer double sided) disc. Moreover, the optical disc 100 is not limited to an optical disc with two recording layers, but may be a multilayer optical disc with three or more recording layers.

(2) Data Structure

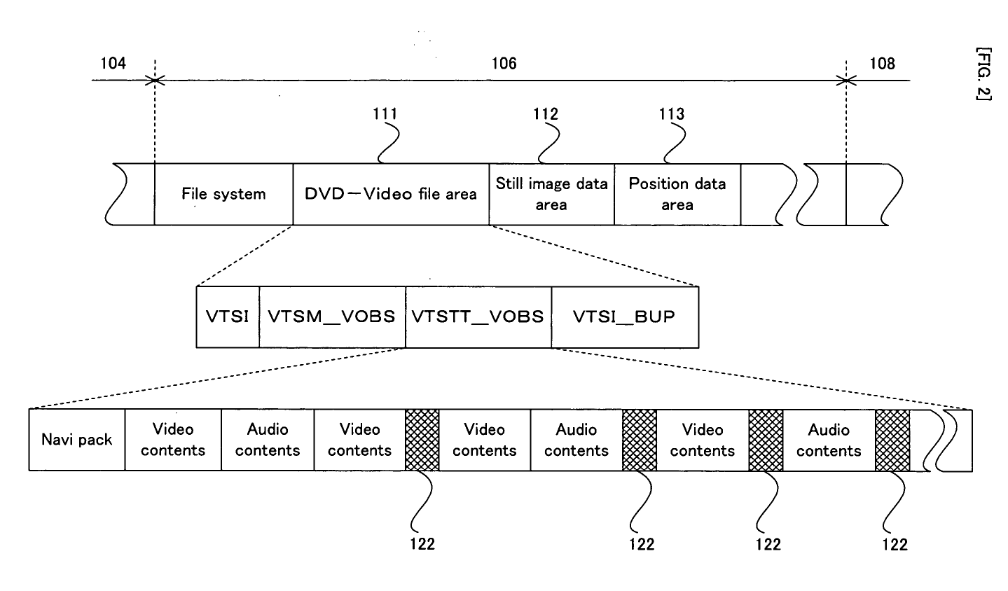

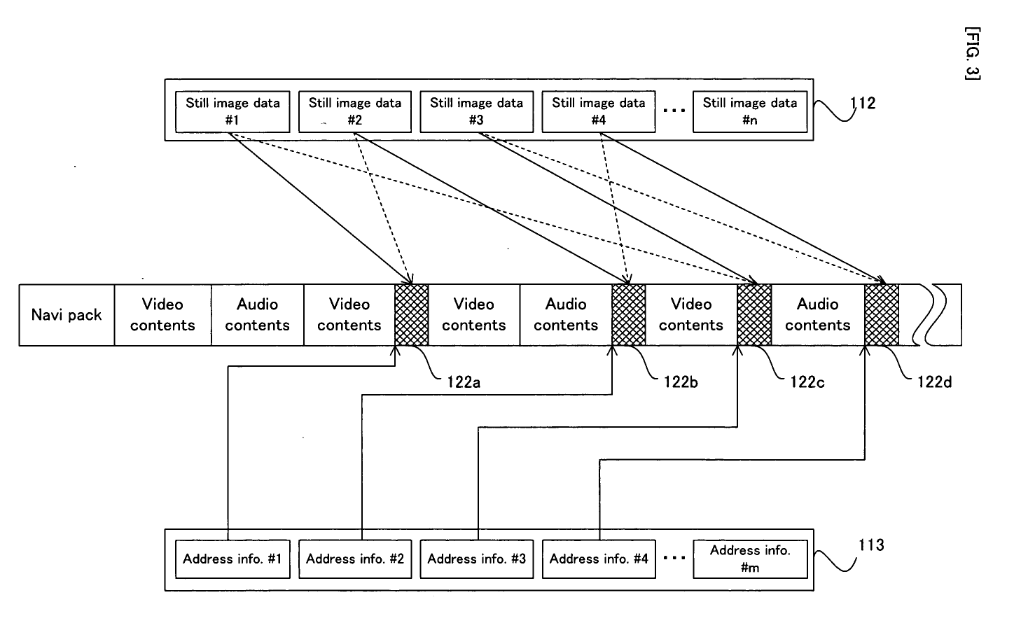

Next, with reference to FIG. 2 and FIG. 3, the specific data structure of the optical disc in the embodiment will be explained. FIG. 2 is an explanatory diagram conceptually showing recording areas further segmentalized in the user data area 106 of the optical disc in the embodiment.

FIG. 3 is an explanatory diagram conceptually showing an aspect in which still image data is recorded into a rewritable area.

As shown in FIG. 2, the user data area 106 is provided with: a file system; a DVD-Video file area 111; a still image data area 112; and a position data area 113.

The file system includes various control information, which is used to reproduce various data (or various files) to be recorded onto the optical disc 100.

The DVD-Video file area 111 is a recording area to record therein a DVD-Video file which is used to reproduce DVD-Video contents. The DVD-Video file area 111, as shown in the middle of FIG. 2, is provided with: VTSI (Video Title Set Information); VTSM_VOBS (Video Object Set for VTS Menu); VTSTT_VOBS (Video Object Set for Titles in VTS); and a VTSI_BUP (VTSI Back Up), as the DVD-Video file. Incidentally, explaining it more specifically, as the DVD-Video file, a VMG (Video Manger) file and a plurality of VTS files, not illustrated, are recorded in the DVD-VIdeo file area 111, and each VTS file includes the above-mentioned VTSI, VTSM_VOBS, VTSTT_VOBS, and VTSI_BUP.

Moreover, the entity of the DVD-Video contents to be reproduced, i.e. the VTSTT_VOB, includes a navi pack, a video pack, and audio pack, or the like. Therefore, these packs or the like are read by an information recording/reproducing apparatus described later, for example, to thereby reproduce the DVD-Video contents.

Particularly in the embodiment, a rewritable area 122 in which the data recorded there can be rewritten is disposed in one portion of the recording area in which the VTSTT_VOB is recorded (i.e. one portion of the DVD-Video file area 111). In the rewritable area 122, predetermined data may be recorded in advance in a rewritable condition, or no data may be recorded. On the other hand, the above-mentioned navi pack, video contents, and audio contents (moreover, VTSI, VTSM_VOB, VTSI_BUP, etc.) recorded in another portion of the recording area are recorded in a non-rewritable condition (or a read-only condition) by using the embossed pit, a pre-record mark or the like. Namely, the rewritable area 122 constitutes one specific example of the “second data area” of the present invention, and the other recording area other than the rewritable area 122 out of the DVD-Video file area 111 constitutes one specific example of the “first data area” of the present invention. Then, each file recorded in advance in the DVD-Video file area 111 constitutes one specific example of the “first data” of the present invention. Moreover, the rewritable area 122 preferably has a data size of an integral multiple of 1ECC block (or 1sector), for example.

The still image data area 112 constitutes one specific example of the “third data area” of the present invention, and it is a recording area to record therein still image data (i.e. one specific example of the “second data” of the present invention), such as JPEG data and bitmap data, for example. The still image data is recorded into the rewritable area 122 disposed in the DVD-Video file area 111 after read from the still image data area 112 by the operation of the information recording/reproducing apparatus described later. The still image data recorded in the still image data area 112 may be recorded in a non-rewritable condition by using the embossed pit, the pre-record mark or the like, for example, or may be recorded in a rewritable condition by using the record mark formed by the irradiation of laser light, for example.

The position data area 113 constitutes one specific example of the “position information area” of the present invention, and it is a recording area to record therein address information or the like, which can specify the position of the rewritable area 122 disposed in the DVD-Video file area 111. The address information or the like may indicate an address position (or an offset address value, etc.) of the rewritable area 122, or may indicate a track number of the rewritable area 122 or the like, for example. Moreover, if there are a plurality of rewritable areas 122, the position of each of the plurality of rewritable areas 122 is indicated by the address information or the like. Moreover, the address information or the like may be recorded in a non-rewritable condition by using the embossed pit, the pre-record mark or the like, for example.

In the rewritable area 122, as shown in FIG. 3, for example, the still image data recorded in the still image data area 112 is recorded as a sub picture pack by the recording operation of the information recording/reproducing apparatus described later. For example, still image data #1 is recorded into a rewritable area 122a, still image data #2 is recorded into a rewritable area 122b, still image data #3 is recorded into a rewritable area 122c, and still image data #4 is recorded into a rewritable area 122d. Alternatively, after any of the still image data #1 to #4 is recorded into the rewritable areas 122a to 122d, still image data #2 may be recorded into the rewritable area 122a again, still image data #4 is recorded into the rewritable area 122b again, still image data #1 is recorded into the rewritable area 122c again, and still image data #3 is recorded into the rewritable area 122d again. Namely, desired still image data can be recorded or rewritten in the rewritable area 122.

Moreover, the positions of the rewritable areas 122a to 122d on the optical disc 100 are specified by the address information recorded in the position data area 113. For example, the position of the rewritable area 122a is specified by referring to address information #1, the position of the rewritable area 122b is specified by referring to address information #2, the position of the rewritable area 122c is specified by referring to address information #3, and the position of the rewritable area 122d is specified by referring to address information #4.

As described above, if the still image data is recorded into the rewritable area 122, it can be reproduced as the DVD-Video contents including the still image data. The various data other than the still image data (e.g. the navi pack, video pack, audio pack, VTSI, VTSM_VOBS, VTSI_BUP, etc.) is recorded in advance, so that a user does not have to record it. In other words, if the user purchases the optical disc 100, the user does not have to perform authoring in order to prepare the optical disc 100 on which the desired DVD-Video contents are recorded. Thus, it is possible to greatly reduce the user's load in recording the DVD-Video contents onto the optical disc 100 and to greatly reduce a time length required for the data recording. This can be realized because both the read-only (i.e. non-rewritable) recording area and the rewritable recording area are mixed without clearly separating the both areas, like the optical disc 100 in the embodiment.

Then, by changing (i.e. rewriting) the still image data recorded in the recordable area 122, as occasion demands, it is possible to reproduce various types of DVD-Video contents including various sub-picture packs. By this, the user can watch the various types of DVD-Video contents. For example, in the case of the DVD-Video contents using the still image data as background data, the background image can be changed, as occasion demands, in accordance with the user's taste.

In addition, the various data other than the still image data is recorded in advance in a non-rewritable condition by using the embossed pit and the prerecord mark or the like, so that it is possible to effectively prevent such a disadvantage that it is mistakenly overwritten or eliminated by the user's operation.

Incidentally, not being limited to the aspect of recording the still image data into the rewritable area 122, as described above, other data (or script data used to reproduce the DVD-Video file, program data, file system, etc.), such as the navi pack, may be recorded into the rewritable area 122. In short, if one portion of data is recorded in advance in a format corresponding to the application to reproduce the optical disc 100 and it is constructed to record another portion of data into the rewritable area 122, it is possible to receive benefits, such as capable of reducing the load required for the authoring, as described above. In other words, any optical disc 100 can receive the above-mentioned benefits if having the image file of the format (i.e. the file as a frame having a form as the format) recorded in advance and if capable of recording the other data (e.g. video data, audio data, still image data, etc.) to be actually reproduced, into a predetermined position of the image file.

Moreover, it is not limited to the optical disc 100 for reproducing the DVD-Video; of course, it may be an optical disc in a format compliant with other various applications. For example, it may be a DVD-VR format for real-time recording. For example, it may be an optical disc or the like capable of reproducing a still-image slide show. Namely, if the application to run the slide show is recorded in advance in the recording area other than the rewritable area 122 in a form of format to run the slide show, it is possible to run the slide show using the still image data (or data obtained by converting the still image data to I pictures), by recording the still image data into the recordable area 122, for example.

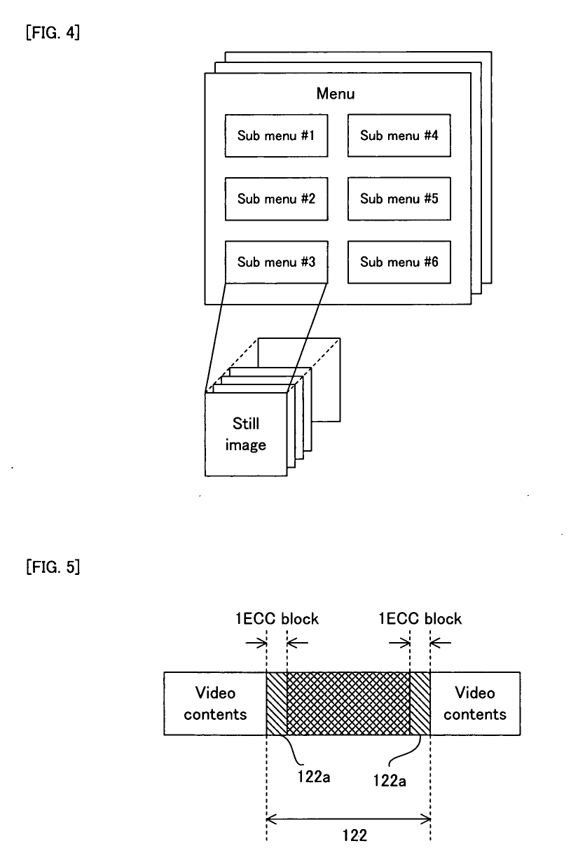

The slide show will be explained more specifically, with reference to FIG. 4. FIG. 4 is an explanatory diagram conceptually showing the basic structure of the slide show.

The data which defines the basic structure of the slide show (e.g. basic structures of a menu screen and a sub menu screen shown in FIG. 4, or the like), for example, is recorded in advance in the form of format to run the slide show by using the embossed pit or the like. For example, the data (data as the frame) that defines the basic structure, which is provided with a plurality of menu screens, each having six sub menu screens in each of which 99 still images can be reproduced in the slide show, is recorded in advance in the form of format to run the slide show. The still images actually used for the slide show are recorded into the rewritable area 122 by the user as the still image data. If the still image data is recorded more than the number displayable on the first menu screen (e.g. the number displayable on the six sub menu screens), the second and third menu screens are newly generated sequentially, on the basis of the data that defines the basic structure of the slide show recorded in advance. Moreover, if the still image data or the like has not been recorded yet, a default image recorded in advance as initial data may be displayed on the first menu screen or the like. Therefore, the user can prepare the optical disc 100 which allows the slide show reproduction using the desired still image, relatively easily, without the authoring process or the like.

Of course, it may be constructed to support other applications other than the slide show.

For example, in case the optical disc 100 in the embodiment is applied to game software or the like, if different data (files) is recorded in the rewritable area 122 in response to clearing stages or clearing a game or the like, the user can play the game on the basis of a different scenario, newly go on to a bonus stage or the like, or watch a different ending screen, so that the user can enjoy a variety of game scenes.

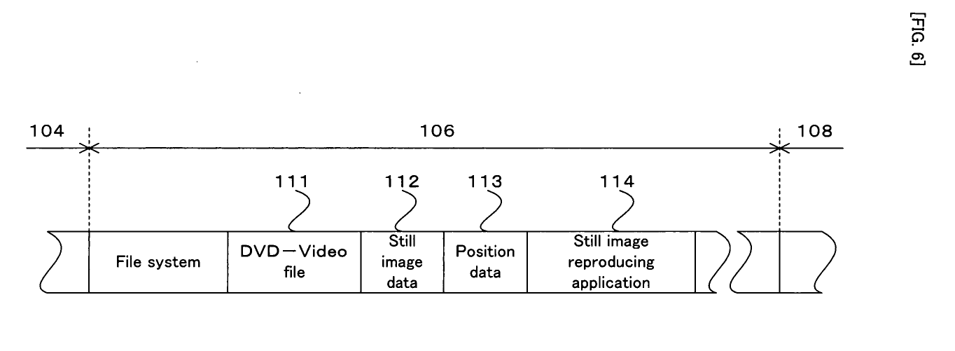

Incidentally, the rewritable area 122 and the other recording area may be not adjacent to each other in their boundary. Such a structure will be explained with reference to FIG. 5. FIG. 5 is an explanatory diagram conceptually showing a dummy area provided on the optical disc 100 in the embodiment.

As shown in FIG. 5, the rewritable area 122 is preferably provided with dummy areas 122a, each having a size of 1ECC block (e.g. size of 32 KB), in boundary portions with the recording areas other than the rewritable area 122. Moreover, the still image data or the like is preferably recorded by a unit of 1ECC block. In the dummy area 122a, predetermined dummy data (e.g. “00h” data, etc.) is preferably recorded, instead of the still image data. By this, without an influence on (or interfering with) the various data recorded in advance in the recording area other than the rewritable area 122, it is possible to preferably record the still image data or the like into the rewritable area 122, for example. In particular, the dummy data is recorded by the ECC block unit and the still image data or the like is recorded from the next ECC block, so that there is also such an advantage that it does not have an adverse effect on error correction by the ECC block unit.

Moreover, in the rewritable area 122, the data may not be recorded a plurality of times, the data may be able to be recorded only once, like a DVD-R, for example. Moreover, from the viewpoint of reducing the authoring load, the various data to be recorded into the recording area other than the rewritable area 122 described above is not necessarily recorded in a non-rewritable condition, and may be recorded in a rewritable condition, for example. Namely, on the entire surface of the optical disc 100, the data may be able to be recorded only once, like a DVD-R and a DVD+R or the like, or the data may be able to be recorded a plurality of times, like a DVD-RW, a DVD+RW, and a DVD-RAM or the like.

### MODIFIED EXAMPLE

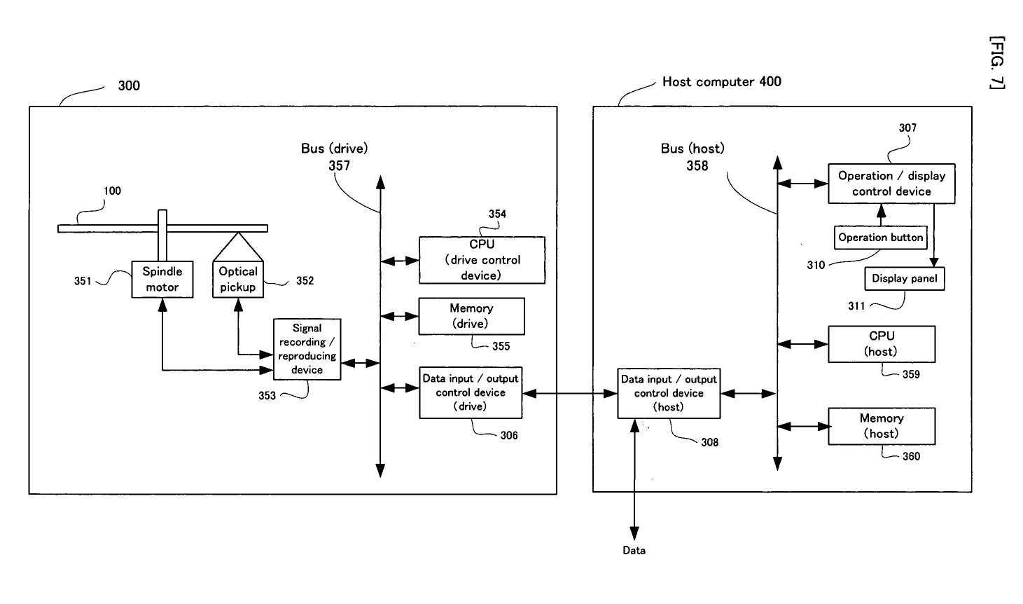

Next, a modified example of the information recording medium of the present invention will be explained, with reference to FIG. 6. FIG. 6 is an explanatory diagram conceptually showing the specific data structure of an information recording medium in the modified example.

On an optical disc 101 in the modified example, as in the above-mentioned optical disc 100, the user data area 106 is also provided with: the file system; the DVD-Video file area 111; the still image data area 112; and the position data 113. Moreover, the data structure in the DVD-Video file area 111 is the same as the data structure shown in FIG. 3.

Particularly in the modified example, the user data area 106 is provided with a still image reproducing application area 114. In the still image reproducing application area 114, a still image reproducing application is recorded, wherein the still image reproducing application can reproduce (i.e. display) the still image data recorded in the still image data area 112, alone. Namely, the still image reproducing application constitutes one specific example of the “second application” of the present invention.

Therefore, if the still image data recorded in the still image data area 112 is recorded into the rewritable area 122 by the operation of a DVD recorder or the like, which is one specific example of the information recording reproducing apparatus, for example, it is possible to reproduce the DVD-Video contents including the still image data. At the same time, if the optical disc 100 is loaded on a PC or the like, for example, the still image reproducing application recorded in the still image reproducing application area 114 is executed, by which the still image data can be reproduced alone. Namely, one still image data can be used in two different applications, so that it is possible to efficiently use the still image data.

(Information Recording/Reproducing Apparatus)

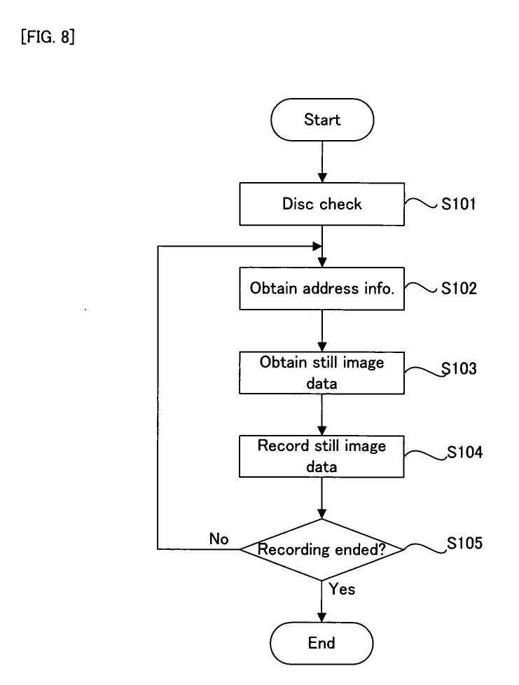

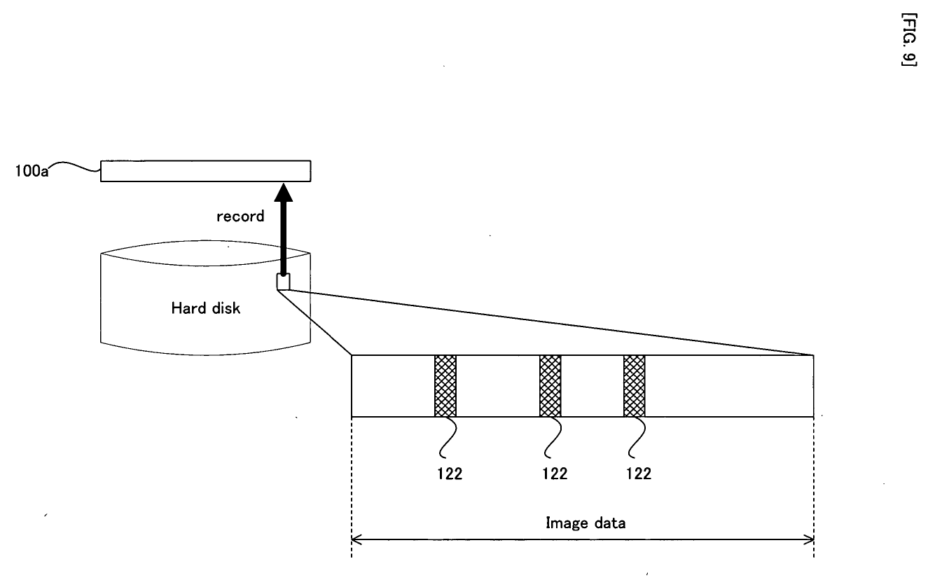

Next, with reference to FIG. 7 and FIG. 8, the information recording/reproducing apparatus will be explained, which is an embodiment of the information recording apparatus of the present invention.

### (1) BASIC STRUCTURE

Firstly, with reference to FIG. 7, the structures of an information recording/reproducing apparatus 300 in the embodiment and a host computer 400 will be explained. FIG. 7 is a block diagram showing the information recording/reproducing apparatus in the embodiment and the host computer. Incidentally, the information recording/reproducing apparatus 300 has a function of recording the record data onto the optical disc 100 and a function of reproducing the record data recorded on the optical disc 100.

As shown in FIG. 7, the information recording/reproducing apparatus 300 is provided with: the optical disc 100; a spindle motor 351; an optical pickup 352; a signal recording/reproducing device 353; a CPU (drive control device) 354; a memory 355; a data input/output control device 306; and a bus 357. Moreover, the host computer 400 is provided with: a CPU 359; a memory 360; an operation/display control device 307; an operation button 310; a display panel 311; and a data input/output control device 308.

The spindle motor 351 is intended to rotate and stop the optical disc 100, and operates in accessing the optical disc 100. More specifically, the spindle motor 351 is constructed to rotate and stop the optical disc 100 at a predetermined speed, under the spindle servo provided by a not-illustrated servo unit or the like.

The optical pickup 352 is provided with a semiconductor laser apparatus and a lens and the like in order to perform the recording/reproducing with respect to the optical disc 100. More specifically, the optical pickup 352 irradiates the optical disc 100 with laser light, as reading light with a first power upon reproduction, and as writing light with a second power with it modulated upon recording.

The signal recording/reproducing device 353 constitutes one specific example of the “recording device” and the “obtaining device” of the present invention, and performs the recording/reproducing with respect to the optical disc 100 by controlling the spindle motor 351 and the optical pickup 352. More specifically, the signal recording/reproducing device 353 is provided with a laser diode (LD) driver, a head amplifier, and the like. The LD driver drives the not-illustrated semiconductor laser apparatus built in the optical pickup 352. The head amplifier amplifies the output signal of the optical pickup 352, i.e., the reflected light of the laser light, and outputs the amplified signal. More specifically, the signal recording/reproducing device 353 drives the not-illustrated semiconductor laser apparatus built in the optical pickup 352, so as to determine the optimum laser power by the recording and reproduction processes of the OPC pattern, along with a not-illustrated timing generator, under the control of the CPU 354, at the time of the OPC process (Optimum Power Control).

The memory 355 is used in the general data processing and the OPC process on the information recording/reproducing apparatus 300, including a buffer area for the record/reproduction data, an area used as an intermediate buffer when data is converted into the data that can be used on the signal recording/reproducing device 353, and the like. Moreover, the memory 355 is provided with: a Read Only Memory (ROM) area into which a program for performing an operation as a recording device, i.e., firmware is stored; a buffer for temporarily storing the record/reproduction data; a Random Access Memory (RAM) area into which a parameter required for the operation of the firmware program or the like is stored; and the like.

The CPU (drive control device) 354 is connected to the signal recording/reproducing device 353 and the memory 355 via the bus 357, and controls the entire information recording/reproducing apparatus 300 by giving instructions to various devices. In general, software or firmware for operating the CPU 354 is stored in the memory 355.

The data input/output control device 306 controls the data input/output from the outside with respect to the information recording/reproducing apparatus 300, and stores the data into or extracts it from a data buffer on the memory 355. A drive control command, which is issued from the external host computer 400 (hereinafter referred to as a host, as occasion demands) connected to the information recording/reproducing apparatus 300 via an interface, such as a SCSI (Small Computer System Interface) and an ATAPI (AT Attachment Packet Interface), is transmitted to the CPU 354 through the data input/output control device 306. Moreover, the record/reproduction data is also exchanged with the host computer 400 through the data input/output control device 306.

The operation/display control device 307 performs the reception of the operation instruction and display with respect to the host computer 400. The operation/display control device 307 sends the instruction to perform the recording or reproduction by using the operation bottom 310, to the CPU 359. The CPU 359 sends a control command to the information recording/reproducing apparatus 300 through the input/output control device 308 on the basis of the instruction information from the operation/display control device 307, to thereby control the entire information recording/reproducing apparatus 300. In the same manner, the CPU 359 can send a command of requiring the information recording/reproducing apparatus 300 to send the operational state to the host, to the information recording/reproducing apparatus 300. By this, it is possible to recognize the operational state of the information recording/reproducing apparatus 300, such as during recording and during reproduction. Thus, the CPU 359 can output the operational state of the information recording/reproducing apparatus 300, to the display panel 311, such as a fluorescent tube and a LCD, through the operation/display control device 307.

The memory 360 is an inner storage device used by the host computer 400, and is provided with: a ROM area into which a firmware program, such as BIOS (Basic Input/Output System), is stored; and a RAM area into which a parameter required for the operation of an operating system, an application program, or the like is stored; and the like. The memory 360 may be also connected to a not-illustrated external storage device, such as a hard disk, through the input/output control device 308.

One specific example in which the information recording/reproducing apparatus 300 and the host computer 400, as explained above, are used together is household equipment, such as recorder equipment for recording/reproducing a video. The recorder equipment records a video signal from a broadcast reception tuner and an external connection terminal, onto a disc, and outputs the video signal reproduced from the disc, to external display equipment, such as a television. The operation as the recorder equipment is performed by executing a program stored in the memory 360, on the CPU 359. Moreover, in another specific example, the information recording/reproducing apparatus 300 is a disc drive (hereinafter referred to as a drive, as occasion demands), and the host computer 400 is a personal computer or a workstation. The host computer 400, such as the personal computer, and the disc drive are connected to each other through the data input/output control devices 306 and 308, such as the SCSI and the ATAPI. An application, such as writing software, which is installed in the host computer 400, controls the disc drive.

### (2) RECORDING OPERATION EXAMPLE

Next, with reference to FIG. 8, the recording operation by the information recording/reproducing apparatus in the embodiment will be explained. FIG. 8 is a flowchart conceptually showing an entire flow of the recording operation. Incidentally, the recording operation explained here is related to the operation of recording the still image data or the like into the rewritable area 122, for example.

As shown in FIG. 8, firstly, the optical disc 100 is loaded onto the information recording/reproducing apparatus 300 and disc check is performed under the control of the CPU 354 (step S101). Namely, the control information required for the data recording is obtained, or the OPC process or the like is performed, for example.

After that, under the control of the CPU 354, the address information or the like recorded in the position data area 113 is obtained (step S102). In particular, it is preferable to selectively obtain the address information or the like about the rewritable area 122 in which the still image data or the like is about to be recorded from now. By this, the information recording/reproducing apparatus 300 can recognize the position of the rewritable area 122 on the optical disc 100.

Then, under the control of the CPU 354, the still image data or the like stored in the still image data area 112 is obtained (step S103). In particular, it is preferable to selectively obtain the still image data or the like which is about to be recorded from now.

After that, the still image data obtained in the step S102 is recorded into the rewritable area 122 indicated by the address information or the like obtained in the step S102 (step S104).

Then, under the control of the CPU 354, it is judged whether or not the recording of the still image data or the like is ended (step S105).

As a result of the judgment, if it is judged that the recording is not ended (the step S105: No), the operational flow returns to the step S102 to thereby continue the recording operation of recording the still image data or the like into the rewritable area 122.

On the other hand, if it is judged that the recording is ended (the step S105: Yes), the recording operation is ended, and a finalize process or file system updating may be performed, or the optical disc 100 may be ejected from the information recording/reproducing apparatus 300.

Consequently, it is possible to preferably record the still image data or the like into the rewritable area 122 provided for the optical disc 100 in the embodiment. Namely, the user does not have to perform the authoring, and can generate the DVD-Video contents in a relatively short time. Of course, in accordance with the various recording aspects described in the explanation of the optical disc 100 described above, the recording operation shown in FIG. 8 may be changed, as occasion demands.

### (3) REPRODUCTION OPERATION EXAMPLE

Next, the reproduction operation of the information recording/reproducing apparatus in the embodiment will be explained. In a case where the DVD-Video contents recorded on the optical disc 100 are reproduced, it is only necessary to perform the same reproduction operation as in the normal case where the DVD-Video contents are reproduced, without being particularly aware of the rewritable area 122 or the like. By this, it is possible to reproduce the desired DVD-Video contents by combining the still image data and the various data (e.g. the navi pack, video pack, audio pack, other VTSI, etc.) recorded in advance in a non-rewritable condition in the recording area other than the rewritable area 122.

Of course, in accordance with the various recording aspects described in the explanation of the optical disc 100 described above, the reproduction operation may be changed, as occasion demands. For example, in case of the reproduction of the information on the optical disc 100 provided with the still image reproducing application area 114, the still image reproducing application may be read onto the CPU-359 on the host computer 400, to thereby reproduce the still image data recorded in the still image data area 112, alone.

### (4) MODIFIED EXAMPLE

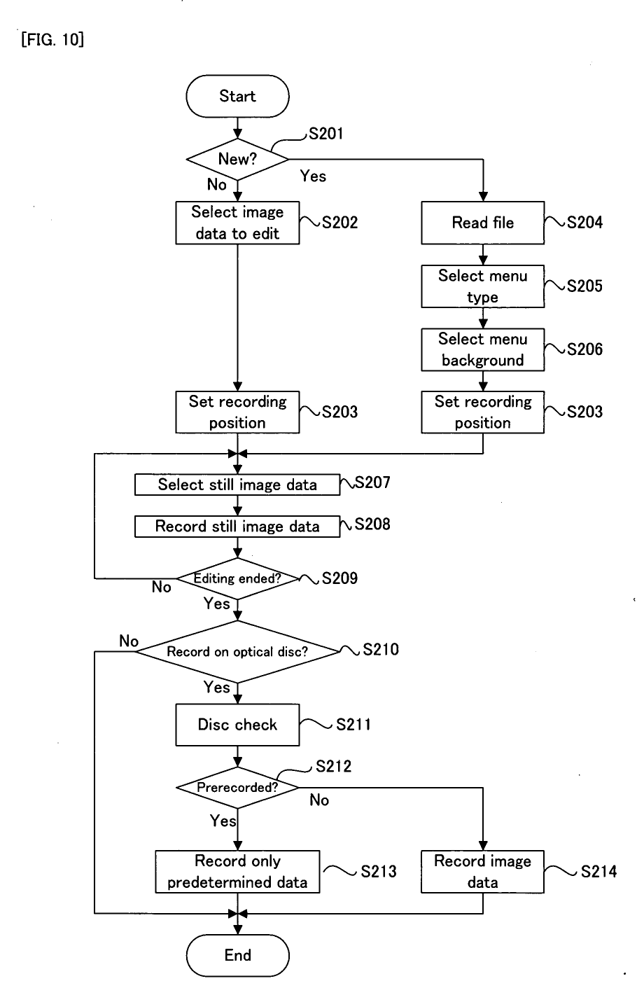

Next, with reference to FIG. 9 and FIG. 10, a modified example of the information recording/reproducing apparatus in the embodiment will be explained. FIG. 9 is an explanatory diagram conceptually showing the recording operation in the modified example. FIG. 10 is a flowchart conceptually showing a flow of the recording operation in the modified example. Incidentally, the modified example shows an aspect of the recording operation of recording the still image data (or including the still image data) recorded on an external recording medium, such as a hard disk, onto an optical disc 100a. In particular, an explanation will be given for the recording operation of recording the file about the slide show.

As shown in FIG. 9, the information recording/reproducing apparatus 300 in the modified example records the data (file) recorded on the external recording medium, such as a hard disk, for example, onto the optical disc 100a. The hard disk is provided in the host computer 400, for example. However, it may be disposed in the information recording/reproducing apparatus 300, or may be provided in equipment other than these apparatuses.

On the hard disk, image data is recorded in advance in a format compliant with the slide show application. Namely, the image data authorized in accordance with the slide show application is recorded. In particular, one portion of the recording area in which the image data is recorded is set as the above-mentioned rewritable area 122 so that the user can record the desired still image data.

Then, if the user records the entire image data onto the optical disc 100a after recording the desired still image data into the rewritable area 122, the user can prepare the optical disc 100a which allows the slide show using the desired still image data. Incidentally, the still image data may be recorded on the hard disk, or may be recorded on a removable recording medium, such as a memory card, for example.

This recording operation will be explained in more detail, with reference to FIG. 10. As shown in FIG. 10, firstly, under the control of the CPU 359, it is judged whether or not new image data is to be generated on the hard disk (step S201). Namely, it is judged whether the image data existing on the hard disk is edited, or the image data is newly generated and edited. The existing image data may be recorded (generated) onto the hard disk by the user, or it may be recorded in advance on the hard disk. Alternatively, it may be automatically generated and recorded, when the slide show application is recorded onto the hard disk provided for the host computer 400, in order to run the slide show.

As a result of the judgment, if it is judged that the new image data is not generated (the step S201: No), then, under the control of the CPU 359, image data on the hard disk to edit is selected (step S202). After that, a recording position on the image data selected in the step S202 on which the still image data or the like is to be recorded is set (step S203). Namely, rewritable are 122 on which the still image data is to be recorded is set, out of one or a plurality of rewritable areas 122 set on the selected image data. After that, the operational flow goes to a step S208.

On the other hand, if it is judged that the new image data is generated (the step S201: Yes), then, the file for generating the image data is read (step S204), the frame of the image data is set. Then, the type of the menu screen (e.g. the structure of the menu screen, the number of sub menu screens, etc.) shown in FIG. 4 is selected (step S205), and further, the background of the menu screen (e.g. background images when the menu screen is displayed, background images when the user reproduces the desired still image data, etc.) is selected (step S206). In this manner, the new image data is generated.

After that, recording position of the generated image data on which the still image data or the like is to be recorded is set (step S203).

Then, the still image data to be recorded on the image data (i.e. to be recorded into the rewritable area 122 out of an image data area) is selected (step S207). After that, the still image data selected in the step S207 is recorded into the rewritable area 122 set in the step S203 (step S207). At his time, in order to preferably include the still image data in the rewritable area, various processes, such as converting the size, may be performed.

After that, it is judged whether or not the editing of the image data (i.e. the recording of the still image data) is ended (step S209).

As a result of the judgment, if it is judged that the editing is not ended (the step S209: No), the operational flow returns to the step S207 again to thereby continue the recording of the still image data. On the other hand, if it is judged that the editing is ended (the step S209: Yes), for example, the edited image data is saved (recorded) onto the hard disk. Then, it is judged whether or not the image data (or one portion thereof) is recorded onto the optical disc 100a (step S210).

As a result of the judgment, if it is judged not to be recorded onto the optical disc 100a (the step S210: No), the recording operation is ended. On the other hand, if it is judged to be recorded onto the optical disc 100a (the step S210: Yes), then, disc check is performed on the optical disc 100a (step S211).

Then, it is judged whether or not the data in the format compliant with the slide show application (e.g. the data necessary to run the slide show, other than the still image data) is prerecorded, for example, as in the DVD-Video file area 111 or the like described above (step S212). Namely, it is judged whether or not the optical disc 100a has the same structure as that of the above-mentioned optical disc 100 in the embodiment.

As a result of the judgment, if it is judged to be prerecorded (the step S212: Yes), the still image data included in the image data is selectively recorded into the rewritable area 122 of the optical disc 100a (step S213). After that, the recording operation is ended.

On the other hand, if it is judged not to be prerecorded for the reason that that the optical disc 100a is a blank disc (i.e. a disc with nothing recorded) or for similar reasons (the step S212: No), the entire image data is recorded onto the optical disc 100a (step S214). After that, the recording operation is ended.

Consequently, according to the modified example, as in the above-mentioned embodiment, the user does not have to perform the authoring, and can generate the various content data, such as slide show contents and DVD-Video contents, for example, in a relatively short time. More specifically, whether the optical disc 100a for recording the content data or the like is the blank disc or not, or whether it is the optical disc 100 on which the data compliant with the predetermined format is prerecorded or not, the user does not have to perform the authoring at the time of the recording onto the optical disc 100, because the image data is generated on the hard disk.

Moreover, the entire image data can be recorded onto the blank disc, so that it is possible to record a series of streams used for the slide show reproduction without dividing it. Namely, in case the still image data is recorded into the rewritable area 122 on the optical disc 100, because the series of streams is not recorded, there is a possibility that DC errors are not be able to be within a predetermined range. However, according to the modified example, the image data can be recorded as the series of streams, there is such a great advantage that the above-mentioned disadvantage does not occur, yet it is also possible to receive the benefit that it is unnecessary to perform the authoring, as described above, which is also greatly advantageous.

Moreover, in the above-mentioned embodiments, the optical disc 100 is explained as one example of the information recording medium, and the recorder related to the optical disc 100 is explained as one example of the information recording apparatus. The present invention, however, is not limited to the optical disc and the recorder thereof, and can be applied to other various information recording media (e.g. a CD, a Blu-ray disc, a HDDVD, etc.), such as a high-density recording medium or a high transfer rate recording medium, and recorders thereof.

Moreover, in the present invention, various changes may be made, if desired, without departing from the essence or spirit of the invention which can be read from the claims and the entire specification. An information recording medium, an information recording apparatus, an information recording method, and a computer program for recording control, which involve such changes, are also intended to be within the technical scope of the present invention.

The information recording medium, the information recording apparatus and method, and the computer program of the present invention can be applied to a high-density information recording medium, such as a DVD, and information recording apparatus, such as a DVD recorder, for example. Moreover, they can be applied to an information recording apparatus or the like, which is mounted on or can be connected to various computer equipment for consumer use or business use, for example.

1-24. (canceled)

25. An information recording medium comprising:
a first data area in which first data having a form compliant with a predetermined format is recorded in advance;
a second data area to record therein second data used with the first data in order to reproduce content data having a form compliant with the predetermined format; and
a third data area in which the second data to be recorded into the second data area is recorded in advance,
the second data area being a blank area.

26. The information recording medium according to claim 25, further comprising a position information area to record therein position information indicating a position of the second data area.

27. The information recording medium according to claim 25, wherein the second data area is disposed in the first data area with being compliant with the predetermined format.

28. The information recording medium according to claim 25, wherein the second data area is provided with a dummy area to record therein dummy data, in a boundary with the first data area.

29. The information recording medium according to claim 25, wherein the second data area has a data size of an integral multiple of a smallest recoding unit.

30. The information recording medium according to claim 25, comprising a plurality of second data areas.

31. The information recording medium according to claim 30, wherein the plurality of second data areas are discretely or continuously disposed in the first data area, with being compliant with the predetermined format.

32. The information recording medium according to claim 25, wherein the first data and the second data are recorded, with being compliant with a first application for performing at least one of recording and reproduction of the content data compliant with the predetermined format.

33. The information recording medium according to claim 32, wherein
the predetermined format is a DVD-Video format,
the first application is a DVD-Video application, and
the second data includes at least one of video data, audio data, and still image data.

34. The information recording medium according to claim 32, wherein
the predetermined format is a DVD-VR format,
the first application is a DVD-VR application, and
the second data includes at least one of video data, audio data, and still image data.

35. The information recording medium according to claim 32, wherein
the predetermined format is a format used for slide show reproduction of still images,
the first application is a slide show application capable of performing the slide show reproduction of still images, and
the second data includes still image data.

36. The information recording medium according to claim 25, further comprising an application area to record therein a second application capable of reproducing the second data recorded in advance in the third data area.

37. An information recording apparatus for recording a second data onto an information recording medium comprising: a first data area in which first data having a form compliant with a predetermined format is recorded in advance; a second data area to record therein second data used with the first data in order to reproduce content data having a form compliant with the predetermined format; and a third data area in which the second data to be recorded into the second data area is recorded in advance, the second data area being a blank are, said information recording apparatus comprising:
an obtaining device for obtaining the second data from the third data area; and
a recording device for recording the obtained second data into the second data area.

38. The information recording apparatus according to claim 37, wherein
the information recording medium further comprises a position information area to record therein position information indicating a position of the second data area,
said information recording apparatus further comprises a recognizing device for recognizing the position of the second data area by referring to the position information, and
said recording device records the second data while referring to the recognized position of the second data area.

39. The information recording apparatus according to claim 37, wherein said recording device records dummy data into a boundary with the first data area out of the second data area.

40. The information recording apparatus according to claim 14, wherein
said recording device converts a size of the obtained second data such that the obtained second data is preferably included in the second data area

41. The information recording apparatus according to claim 37, wherein said obtaining device obtains the second data from an external recording device on which the second data is recorded in advance.

42. The information recording apparatus according to claim 41, wherein the second data is recorded on the external recording device having a form compliant with the predetermined format.

43. The information recording apparatus according to claim 37, wherein the predetermined format is a DVD-Video format, and
said recording device records at least one of video data, audio data, and still image data, as the second data.

44. The information recording apparatus according to claim 37, wherein the predetermined format is a DVD-VR format, and
said recording device records at least one of video data, audio data, and still image data, as the second data.

45. The information recording apparatus according to claim 37, wherein the predetermined format is a format used for slide show reproduction of still images,
said recording device records at least still image data, as the second data.

46. An information recording method of recording a second data onto the information recording medium comprising: a first data area in which first data having a form compliant with a predetermined format is recorded in advance; a second data area to record therein second data used with the first data in order to reproduce content data having a form compliant with the predetermined format; and a third data area in which the second data to be recorded into the second data area is recorded in advance, the second data area being a blank area, said information recording method comprising:
an obtaining process of obtaining the second data from the third data area; and
a recording process of recording the obtained second data into the second data area.

47. A computer program product in a computer-readable medium for tangibly embodying a program of instructions executable by a computer provided in an information recording apparatus, to make the computer function as at least one portion of an obtaining device and a recording device,
said information recording apparatus for recording a second data onto an information recording medium comprising: a first data area in which first data having a form compliant with a predetermined format is recorded in advance; a second data area to record therein second data used with the first data in order to reproduce content data having a form compliant with the predetermined format; and a third data area in which the second data to be recorded into the second data area is recorded in advance, the second data area being a blank area, said information recording apparatus comprising:
said obtaining device for obtaining the second data from the third data area; and
said recording device for recording the obtained second data into the second data area.

48. An information recording medium comprising:
a first data area in which non-rewritable first data having a form compliant with a predetermined format is recorded in advance; and
a second data area to record therein rewritable second data used with the first data in order to reproduce content data having a form compliant with the predetermined format,
the second data area being a blank area.

49. The information recording medium according to claim 48, further comprising a position information area to record therein position information indicating a position of the second data area.

50. The information recording medium according to claim 48, wherein the second data area is provided with a dummy area to record therein dummy data, in a boundary with the first data area.

51. The information recording medium according to claim 48, comprising a plurality of second data areas,
the plurality of second data areas being discretely or continuously disposed in the first data area, with being compliant with the predetermined format.

52. An information recording apparatus for recording a second data onto an information recording medium comprising: a first data area in which non-rewritable first data having a form compliant with a predetermined format is recorded in advance; and a second data area to record therein rewritable second data used with the first data in order to reproduce content data having a form compliant with the predetermined format, the second data area being a blank area, said information recording apparatus comprising:
an obtaining device for obtaining the second data; and
a recording device for recording the obtained second data into the second data area.

53. The information recording apparatus according to claim 52, wherein
the information recording medium further comprises a position information area to record therein position information indicating a position of the second data area,
said information recording apparatus further comprises a recognizing device for recognizing the position of the second data area by referring to the position information, and
said recording device records the second data while referring to the recognized position of the second data area.

54. The information recording apparatus according to claim 52, wherein said recording device records dummy data into a boundary with the first data area out of the second data area.

55. The information recording apparatus according to claim 52, wherein
said recording device converts a size of the obtained second data such that the obtained second data is preferably included in the second data area

56. An information recording method of recording a second data onto an information recording medium comprising: a first data area in which non-rewritable first data having a form compliant with a predetermined format is recorded in advance; and a second data area to record therein rewritable second data used with the first data in order to reproduce content data having a form compliant with the predetermined format, the second data area being a blank area, said information recording method comprising:
an obtaining process of obtaining the second data; and
a recording process of recording the obtained second data into the second data area.

57. A computer program product in a computer-readable medium for tangibly embodying a program of instructions executable by a computer provided in an information recording apparatus, to make the computer function as at least one portion of an obtaining device and a recording device,
said information recording apparatus for recording a second data onto an information recording medium comprising: a first data area in which non-rewritable first data having a form compliant with a predetermined format is recorded in advance; and a second data area to record therein rewritable second data used with the first data in order to reproduce content data having a form compliant with the predetermined format, the second data area being a blank area, said information recording apparatus comprising:
said obtaining device for obtaining the second data; and
said recording device for recording the obtained second data into the second data area.
